(19) United States
(12) Patent Application Publication
(10) Pub. No.: US 2023/0182607 A1
(43) Pub. Date: Jun. 15, 2023

(54) INFORMATION PROCESSING APPARATUS, SYSTEM, METHOD AND PROGRAM

(71) Applicant: Ubiden Inc., Tokyo (JP)

(72) Inventors: Norio Yamaguchi, Tokyo (JP); Tatsuro Shiraishi, Tokyo (JP); Shuhei Onishi, Tokyo (JP); Hitoshi Ikeda, Tokyo (JP)

(73) Assignee: Ubiden Inc., Tokyo (JP)

(21) Appl. No.: 17/923,948

(22) PCT Filed: Dec. 23, 2020
(86) PCT No.: PCT/JP2020/048179

§ 371 Date: Nov. 8, 2022

(30) Foreign Application Priority Data
May 15, 2020 (JP) 2020-085791

(51) Int. Cl. B60L 53/66; B60L 53/16; B60L 53/65; B60L 53/68

(52) U.S. Cl. CPC B60L 53/66; B60L 53/16; B60L 53/65; B60L 53/68; B60L 2240/72

(57) ABSTRACT

An energy usage management with less equipment load and processing load is realized. An information processing apparatus 100 for managing a use of an energy comprises a detection section (gate communication section 101) that performs a detection of an energy supply target (vehicle) existing in each disposing area where an energy output section is disposed, a supply information acquisition section (supply-target communication section 102) that acquires supply information of energy (electric power usage information) to be supplied to the supply target detected by the detection section, and an association processing section (management processing section 103) that performs a process of associating with identification information of the supply target detected by the detection section, supply information corresponding to the supply target, the supply information being acquired by the supply information acquisition section, and identification information of a disposing area (parking identification information) in which the supply target is detected by the detection section.

### TECHNICAL FIELD

The present invention relates to information processing apparatuses, systems, methods and programs that manage a use of an energy such as an electric power.

### BACKGROUND ART

A system of managing a power usage via an electrical outlet is conventionally known. For example, Patent Literature 1 discloses a system provided with a power-supply gate apparatus that receives a power from a power line and controls a power supply based on key code information, a server apparatus that transmits key code information corresponding to ID code information unique to the power-supply gate apparatus, and a mobile outlet. When the mobile outlet is attached to the power-supply gate apparatus, the mobile outlet receives ID code information from the power-supply gate apparatus, receives key code information corresponding to the ID code information from the server apparatus, and provides this key code information to the power-supply gate apparatus. Thus, a power usage via the mobile outlet is possible.

### CITATION LIST

### Patent Literature

Patent Literature 1: Japanese Unexamined Patent Application Publication No. 2002-325357.

### SUMMARY OF INVENTION

### Technical Problem

In the conventional system, the power-supply gate apparatus (energy output section) is individually figured out by ID code information (identification information) and the power usage is managed, therefore there is a problem that equipment load and processing load are large.

### Solution to Problem

An information processing apparatus according to an aspect of the present invention is an information processing apparatus for managing a use of an energy. This information processing apparatus comprises a detection section that performs a detection of an energy supply target existing in each disposing area where an energy output section is disposed, a supply information acquisition section that acquires supply information of energy to be supplied to the supply target detected by the detection section, and an association processing section that executes a process of associating with identification information of the supply target detected by the detection section, supply information corresponding to the supply target, the supply information being acquired by the supply information acquisition section, and identification information of a disposing area in which the supply target is detected by the detection section.

In the foregoing information processing apparatus, the disposing area may be set by partitioning so as to include only the energy output section managed by a same energy business operator.

Also, the foregoing information processing apparatus may comprise a fee-charge processing section that performs a fee-charge process for a usage fee of the energy supplied to the supply target from the energy output section managed by the energy business operator, with respect to the energy business operator that manages the disposing area identified based on the identification information of the disposing area associated by the association processing section.

Also, in the foregoing information processing apparatus, the detection section may perform the detection by acquiring detection information obtained by detecting a passage of the supply target to the disposing area by a gate apparatus disposed at least one of an entrance and an exit of the disposing area.

Also, in the foregoing information processing apparatus, the detection section may perform the detection based on position information of the supply target and position information of the disposing area.

Also, in the foregoing information processing apparatus, the supply information acquisition section may acquire the supply information transmitted from communication apparatus mounted on the supply target or moving together with the supply target.

Also, in the foregoing information processing apparatus, the energy used in the supply target may be an electric power, the supply information may include an amount of the electric power used in the supply target.

Also, in the foregoing information processing apparatus, the supply target may be a vehicle.

A system according to another aspect of the present invention is a system for managing a use of an energy. This system comprises the foregoing information processing apparatus and at least one of a communication apparatus that transmits information used by the detection section to perform the detection, to the information processing apparatus, and a communication apparatus that transmits the supply information acquired by the supply information acquisition section to the information processing apparatus.

A method according to still another aspect of the present invention is a method for managing a use of an energy. This method comprises a detection process of performing a detection of an energy supply target existing in each disposing area where an energy output section is disposed, an acquisition process of performing an acquisition of supply information of energy to be supplied to the supply target detected in the detection process, and a processing process of executing a process of associating with identification information of the supply target detected in the detection process, supply information corresponding to the supply target, the supply information being acquired in the acquisition process, and identification information of a disposing area in which the supply target is detected in the detection process.

A program according to still another aspect of the present invention is a program executed in a computer provided in an information processing apparatus that manages a use of an energy. This program causes the computer to execute a detection process of performing a detection of an energy supply target existing in each disposing area where an energy output section is disposed, an acquisition process of performing an acquisition of supply information of energy to be supplied to the supply target detected in the detection process, and a processing process of executing a process of associating with identification information of the supply target detected in the detection process, supply information corresponding to the supply target, the supply information being acquired in the acquisition process, and identification information of a disposing area in which the supply target is detected in the detection process.

### Advantageous Effects of Invention

According to the present invention, it is capable of realizing an energy usage management with less equipment load and processing load.

### BRIEF DESCRIPTION OF DRAWINGS

FIG. 1 is an explanatory diagram showing a disposing area in which an electrical outlet is disposed, which configures a power-usage management system according to an embodiment 1.

FIG. 2 is an explanatory diagram showing an example of a schematic configuration of the power-usage management system.

FIG. 3 is a block diagram showing an example of a configuration of main functions of a server which configures the power-usage management system.

FIG. 4 is a sequence diagram showing an example of a power-usage management process in the embodiment 1.

FIG. 5 is an explanatory diagram showing a disposing area in which an electrical outlet is disposed, which configures a power-usage management system according to an embodiment 2.

FIG. 6 is an explanatory diagram showing an example of a schematic configuration of the power-usage management system.

FIG. 7 is a block diagram showing an example of a configuration of main functions of a server which configures the power-usage management system.

FIG. 8 is a sequence diagram showing an example of a power-usage management process in the embodiment 2.

### DESCRIPTION OF EMBODIMENTS

### Embodiment 1

Hereinafter, an embodiment of the present invention (hereinafter, this embodiment will be referred to as “embodiment 1”) is described with reference to the drawings.

A system according to the embodiment 1 of the present invention is a system that manages a use of an energy supplied from an energy output section and used in a supply target. The energy to be used may be, for example, a primary energy in the form of oil, natural gas, coal, or the like, or a secondary energy in the form of electricity, hydrogen, gasoline, light oil, heavy oil, city gas, alcohol, or the like. A supply target to which an energy is supplied is, for example, an electric moving body driven by a battery-mounted motor. The moving body may be a moving body moving on the ground such as an electric vehicle or a fuel cell vehicle, a moving body moving through the air such as a drone, or a moving body such as a ship moving on water such as the sea. The moving body may be a vehicle having four or more wheels, a three-wheeled vehicle (tricycle), a two-wheeled vehicle (motorcycle, bicycle), a truck, a bus, a private vehicle, a commercial vehicle, or the like. The battery may be owned by the user oneself, may be leased from a leasing company, or may be owned by a business operator different from the user. Further, the supply target may be an electric device or an electronic device such as a portable or stationary home appliance, an office device and a communication terminal apparatus.

In the following embodiment 1, as an example, a case is described in which an energy to be used is an electric energy, an energy output section that outputs the energy is an electrical outlet that outputs an electrical energy, a supply target to which an energy is supplied is a battery which is installed in a vehicle, and a system is a power-usage management system that manages a power usage when electrically charging the battery of the vehicle with the electric power output from the electrical outlet.

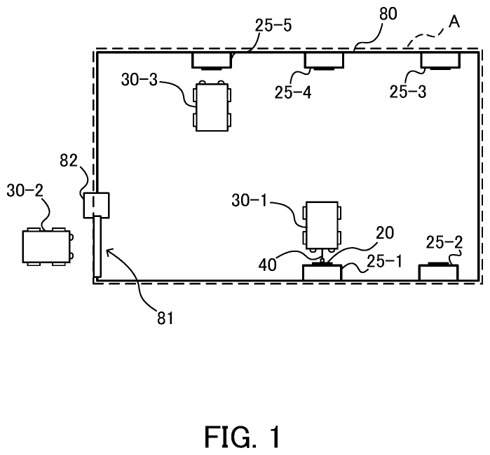

FIG. 1 is an explanatory diagram showing a disposing area in which an electrical outlet 20 is disposed, which configures a power-usage management system 10 according to the present embodiment 1.

The disposing area A shown in FIG. 1 is set on a site of a parking place 80 having parking spaces in which a plurality of vehicles 30-1 to 30-3 can be parked. A location where the vehicles 30-1 to 30-3 can enter and exit the parking place 80 is one entrance/exit gate 81. A gate apparatus 82 is disposed at the entrance/exit gate 81 of the parking place 80. This gate apparatus 82 has a function of identifying vehicles 30 entering and exiting the parking place 80 (disposing area).

In the parking place 80, charging stands 25-1 to 25-5 each equipped with an electrical outlet 20 are disposed near each parking space. In the example of FIG. 1, five charging stands 25-1 to 25-5 are disposed in the parking place 80, but the number of charging stands disposed in the parking place is arbitrary, and may be one or more. Note that the disposing area A in the present embodiment 1 is outdoors, but may be indoors.

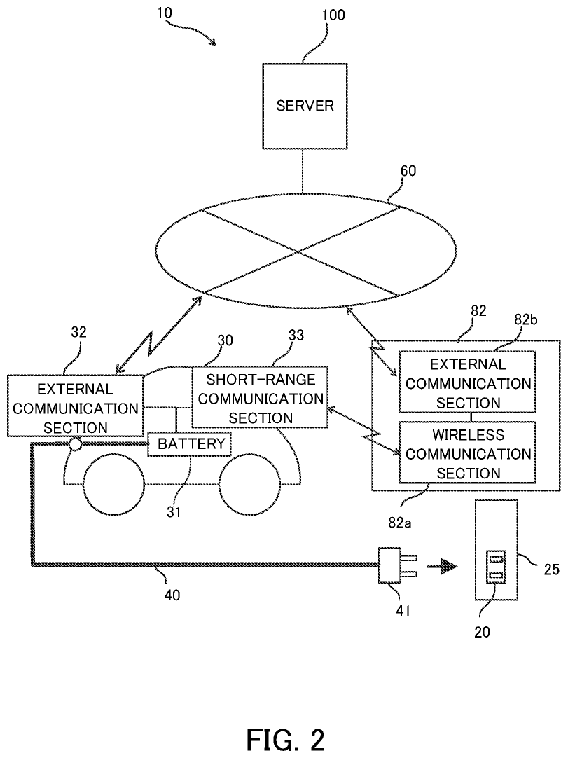

FIG. 2 is an illustration showing an example of a schematic configuration of the power-usage management system 10 according to the present embodiment 1.

In FIG. 2, the power-usage management system 10 manages an electric power usage of a supply target to which an electric power is supplied from the electrical outlet 20. The supply target in the present embodiment 1 is a battery 31 of the vehicle 30, which is charged by the electric power from the electrical outlet 20. The power supply from the electrical outlet 20 is performed via, for example, a wired power cable 40 and a plug 41. The power supply from the electrical outlet 20 may be performed by a wireless power supply such as an electromagnetic induction, a power supply by a radio wave such as a microwave and a power supply by a light such as a laser light. Further, the voltage (current) supplied from the electrical outlet 20 may be alternating current or direct current.

The power-usage management system 10 includes a server 100 as an information processing apparatus that manages a usage of an electric power (electrical energy). The server 100 may be configured by a single computer apparatus, may be configured to link a plurality of computer apparatuses, or may be configured by a cloud system on a network.

The electrical outlet 20 as an energy output section capable of outputting an electric power (electrical energy) may be a general-purpose outlet with no limitation of use, or may be a dedicated outlet with a limitation of use. Further, the electrical outlet 20 may be an electrical outlet for which a user is not limited, or an electrical outlet that can be used only by a specific user.

The gate apparatus 82 disposed at the entrance/exit gate 81 of the parking place 80 includes a wireless communication section 82a capable of short-range wireless communication such as a wireless LAN or Bluetooth (registered trademark) with a short-range communication section 33 mounted on the vehicle 30 passing through the entrance/exit gate 81. The wireless communication section 82a receives identification information (identification information of the supply target) for identifying the vehicle 30 or the battery 31 from the short-range communication section 33 of the vehicle 30 passing through the entrance/exit gate 81. In the present embodiment 1, for example, vehicle identification information for identifying the vehicle 30 is transmitted from the short-range communication section 33 of the vehicle 30 to the wireless communication section 82a of the gate apparatus 82.

The gate apparatus 82 of the present embodiment 1 only needs to acquire identification information that can identify the vehicle 30 passing through the entrance/exit gate 81. Therefore, a method of the acquisition is not limited to the method of receiving the identification information transmitted from the vehicle 30 by the wireless communication section 82a as described above. For example, a license plate (vehicle registration number certificate) of the vehicle 30 passing through the entrance/exit gate 81 is imaged using an imaging apparatus such as a camera, and the vehicle registration number of the vehicle 30 recognized from the obtained image is acquired as identification information. In addition, identification information of the vehicle received from an ETC (Electronic Toll Collection System) in-vehicle equipment installed in the vehicle may be used.

In addition, the identification information of the vehicle 30 acquired by the gate apparatus 82 is ultimately used for identifying the vehicle 30 in the server 100 of this system, but it does not need to be the identification information itself used for processing in the server 100. That is, the identification information of the vehicle 30 acquired by the gate apparatus 82 may be identification information in a different format associated with the identification information used for processing in the server 100.

When the gate apparatus 82 acquires the identification information of the vehicle 30 passing through the entrance/exit gate 81, the external communication section 82b transmits the identification information to the server 100 via a communication network 60 such as a mobile communication network or the Internet. At this time, entering/exiting information for distinguishing between entering and exiting the parking place and identification information (identification information of disposing area) for identifying the parking place 80 or the gate apparatus 82 are also transmitted. In the present embodiment 1, an example in which parking identification information for identifying the parking place 80 is used as the identification information of disposing area will be described.

The vehicle 30 can perform short-range wireless communication with the wireless communication section 82a of the gate apparatus 82 by the short-range communication section 33 mounted on the vehicle, and communicate with the server 100 via the communication network 60 by the external communication section 32 mounted on the vehicle. The external communication section 32 and the short-range communication section 33 may be, for example, a remote control unit (TCU: Telematics Control Unit) connected to an in-vehicle network (CAN: Controller Area Network) via a gateway. The in-vehicle network (CAN) is connected to a battery management system (BMS) that manages the battery 31 and one or more electronic control units (ECU) that control other parts, in addition to the remote control unit (TCU).

Power usage information (for example, battery identification information, amount of electric power, power-charging start time, power-charging end time, etc.) regarding the electric power used for charging the battery 31 can be transmitted, for example, from the battery management system (BMS) to the server 100 via the remote control unit (TCU). Vehicle identification information can be transmitted, for example, from the electronic control unit (ECU) having a memory storing basic information of the vehicle, to the server 100 and the gate apparatus 82 via the remote control unit (TCU).

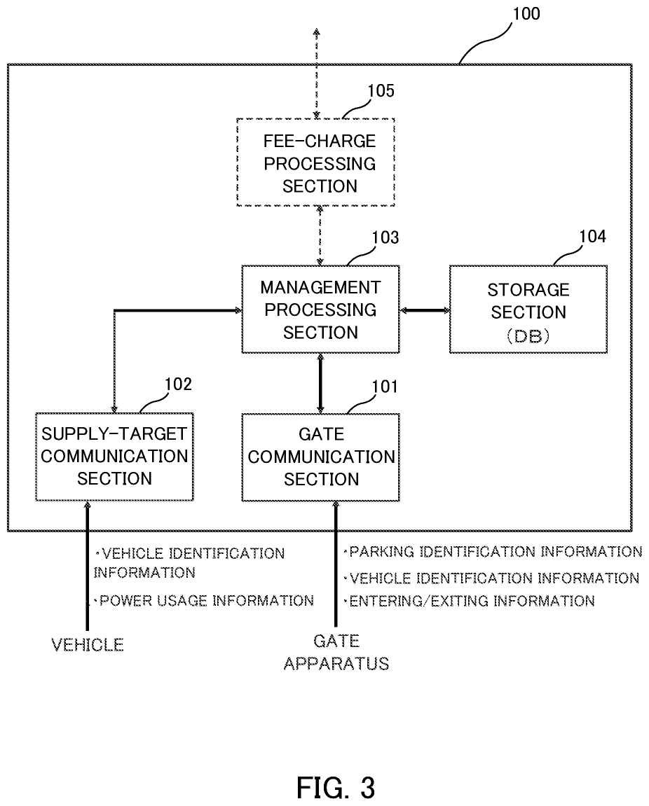

FIG. 3 is a block diagram showing an example of a configuration of main functions of the server 100 according to the embodiment 1. In FIG. 3, the server 100 includes a gate communication section 101, a supply-target communication section 102, a management processing section 103, and a storage section (DB: database) 104.

The gate communication section 101 receives the parking identification information (identification information of disposing area) for identifying the parking place 80 from the gate apparatus 82 disposed in each parking place 80 (disposing area) via the communication network 60, as well as the vehicle identification information and the entering/exiting information of the vehicle 30 entering or exiting the parking place 80 (disposing area). The gate communication section 101 functions as a detection section, and by receiving such information, can detect the vehicle 30 or the battery 31, which is supply target of the energy existing inside the parking place, in each parking place 80 (disposing area).

The supply-target communication section 102 has a function as a supply information acquisition section, and receives, from the vehicle 30 which is the supply target, the vehicle identification information which is the identification information of the supply target and the power usage information (for example, battery identification information, amount of electric power, power-charging start time, power-charging end time) which is the supply information supplied from the electrical outlet 20 to the battery 31 of the vehicle 30.

Note that the gate communication section 101 and the supply-target communication section 102 may be configured as an integrally configured communication apparatus (for example, a mobile communication module).

The management processing section 103 performs various types of process such as an association process for associating the parking identification information, which is the identification information of the disposing area, the vehicle identification information, which is the identification information of the supply target, and the power usage information, which is the supply information, an authentication process of the user or the supply target (for example, the vehicle 30 or the battery 31), and a power-usage management process for managing the power usage information for each user or supply target.

As the association process in the present embodiment 1, the management processing section 103 registers the parking identification information, the vehicle identification information and the entering/exiting information received by the gate communication section 101 from the gate apparatus 82 at an area stay database in the storage section 104. Specifically, it determines whether the vehicle has entered or exited based on the entering/exiting information. For example, in the entering case, the vehicle identification information is associated with the parking identification information and registered in the area stay database, and in the exiting case, the vehicle identification information registered in association with the parking identification information is deleted from the area stay database. As a result, the vehicle identification information of all the vehicles 30 existing (staying) in each of the parking spaces 80, in which the electrical outlets 20 managed by the server 100 is disposed, is registered in the area stay database.

Further, as authentication process in the present embodiment 1, the management processing section 103 performs a user authentication which confirms whether the user is an authorized user previously registered in a predetermined power-usage management service by comparing the vehicle identification information received by the supply-target communication section 102 from each vehicle 30 with the vehicle identification information previously registered in the server 100. Specifically, a user registration database that associates identification information of authorized user with authorized vehicle identification information is stored in the storage section 104, and after confirming that the vehicle identification information received by the supply-target communication section 102 from each vehicle 30 is registered in the user registration database, it is determined that the user of the received vehicle identification information is the authorized user. In the case of authorized users, usage of the power-usage management service may be permitted, and in the case of non-authorized users, usage of the power-usage management service may be restricted (for example, usage is not permitted).

Also, as the power-usage management process in the present embodiment 1, the management processing section 103 registers the power usage information received by the supply-target communication section 102 from each vehicle 30 at the power-usage management database in the storage section 104. Specifically, a power amount information included in the power usage information received from each vehicle 30 is associated with the vehicle identification information of the vehicle 30 (or the user identification information associated with the vehicle identification information), and registered at the power-usage management database.

At this time, the management processing section 103 refers to the area stay database in the storage section 104 and confirms in which parking space 80 the vehicle 30 corresponding to the vehicle identification information exists (stays), and then acquires the parking identification information of the confirmed parking space 80. Then, the management processing section 103 refers to the business-operator database in the storage section 104 and confirms which business operator corresponds to the parking identification information, and then acquires the business operator identification information of the confirmed business operator and registers this business operator identification information in the power-usage management database together with the power amount information included in the power usage information received from the vehicle 30.

Here, the business-operator database stored in the storage section 104 of the present embodiment 1 stores the parking identification information for identifying each parking space 80 in association with a power-usage management service business operator (hereinafter, simply referred to as “business operator”), as an energy business operator, which provides the power-usage management services by using the electrical outlets 20 disposed in each parking space 80.

The system of the present embodiment 1 may be a system in which electrical outlets 20 managed by a plurality of business operators are mixed. In this case, when electric power (electrical energy) is supplied from any electrical outlet 20 belonging to this system to the battery 31 of the vehicle 30, it is necessary to specify which business operator manages the supplied electrical outlet 20. At this time, in a method of managing the business operator and the individual electrical outlets 20 in association with each other such as that of the conventional system, it is necessary to individually grasp the electrical outlets 20 which have supplied electric power to the battery 31 of the vehicle 30, thereby easily increasing the equipment load for this grasping and the processing load for this grasping.

For example, in order to individually grasp the electrical outlets 20 that have supplied power to the battery 31 of the vehicle 30, if all the electrical outlets 20 are provided with equipment (such as a communication apparatus) for transmitting their own identification information to the server 100, the equipment load is large. Also, in order to individually grasp the electrical outlets 20 that have supplied power to the battery 31 of the vehicle 30, if all the electrical outlets are assigned identification information and the power usage information is managed for each electrical outlet, the processing load is large.

Therefore, in the present embodiment 1, the disposing area is set so as to include only electrical outlets 20 managed by the same business operator. That is, the electrical outlets 20 of five charging stands 25-1 to 25-5 disposed in the parking space 80 shown in FIG. 1 set as the disposing area is managed by the same business operator to provide the power-usage management service. By setting the disposing area in this way, it is possible to establish a one-to-one correspondence between the disposing area and the business operator. As a result, even if the electrical outlet 20 that has supplied electric power to the battery 31 of the vehicle 30 cannot be grasped individually, as long as the disposing area (parking space 80) where the electrical outlet 20 is disposed can be grasped, it is possible to specify the business operator to manage the electrical outlet 20.

Hence, according to the system of the present embodiment 1, even when the electrical outlets 20 managed by a plurality of business operators are mixed, in identifying the business operator when electric power is supplied from the electrical outlet 20 to the battery 31 of the vehicle 30, merits such as less equipment load and less processing load can be obtained. In particular, in a distributed power supply system, in an area where a plurality of business operators each managing and operating a power generation apparatus such as a solar power generator gather, there are many cases where the electrical outlets 20 managed by each business operator are mixed, therefore the merits of the present embodiment are great.

In particular, as in the present embodiment 1, when the gate apparatus 82 disposed at the entrance/exit gate 81 of the parking space is used to detect the vehicle 30 existing in the parking space 80 (disposing area), it is possible to use equipment used in the existing services such as a gate apparatus of a pay-parking (gate apparatus having a function of detecting vehicles 30 entering and exiting a parking space 80 (disposing area) in order to charge a parking fee). Therefore, in the present embodiment 1, it is possible to reduce the equipment load and the processing load.

In the present embodiment 1, the server 100 may be provided with a fee-charge processing section 105. The fee-charge processing section 105 performs a process of fee-charging to users with respect to a usage fee of power usage by the vehicle 30 via the electrical outlet 20. In the present embodiment 1, the process is performed to provide the business operator with the information necessary for the business operator of the electrical outlet 20 to charge the user for the usage fee of power usage by the vehicle 30 through the electrical outlet 20. Specifically, in the power-usage management database in the storage section 104, the process is performed to provide each business operator with the user identification information stored in association with the business operator identification information of each business operator and the power usage information (power amount information, etc.) in association with the user identification information. It should be noted that the process for charging each user may be performed in the server 100 on behalf of the business operator.

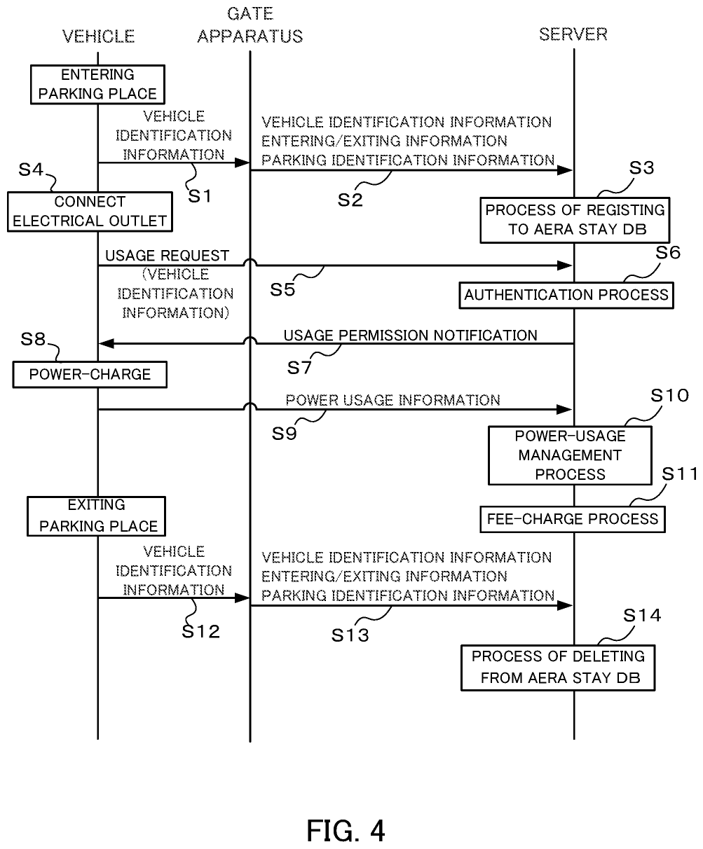

FIG. 4 is a sequence diagram showing an example of the power-usage management process in the present embodiment 1.

The storage section 104 of the server 100 is input data to the user registration database by an operator or the like in advance, and then stores the identification information of the authorized users, the vehicle identification information of the vehicles used by the users and the business operator identification information of the business operator of the power-usage management service used by the user in association with each other. Further, the storage section 104 of the server 100 is input data to the business-operator database by an operator or the like in advance, and then stores identification information of the business operators and the parking identification information of the parking spaces 80 where the electrical outlets 20 managed by the business operators is disposed in association with each other.

When the vehicle 30 enters the parking space 80 through the entrance/exit gate 81 of the parking space 80, the gate apparatus 82 communicates with the short-range communication section 33 of the vehicle 30 by the wireless communication section 82a to receive the vehicle identification information of the vehicle 30 from the vehicle 30 (S1). Then, the gate apparatus 82 transmits the received vehicle identification information to the server 100 via the communication network 60 together with the entering/exiting information at the time of entering and the parking identification information of the parking space 80 by the external communication section 82b (S2).

The management processing section 103 of the server 100 registers the vehicle identification information, the entering/exiting information and the parking identification information received from the gate apparatus 82 by the gate communication section 101 at the area stay database in the storage section 104. Here, since the entering/exiting information indicates the time of entering, the vehicle identification information is registered at the area stay database in association with the parking identification information (S3).

Subsequently, when the vehicle 30 receives electric power from the electrical outlet 20 of the charging stand 25 in the parking space 80 to charge the battery 31, a plug 41 of a power cable 40 of the vehicle 30 is connected to the electrical outlet 20 (S4). As a result, a usage request including the vehicle identification information of the vehicle 30 is transmitted from the external communication section 32 of the vehicle 30 to the server 100 via the communication network 60 (S5).

When this usage request is received by the supply-target communication section 102 of the server 100, authentication process is executed in the management processing section 103 (S6). In this authentication process, it is confirmed whether or not the vehicle identification information included in the usage request belongs to the authorized user registered at the user registration database in storage section 104.

At this time, even if the vehicle identification information included in the usage request is registered at the user registration database, it is necessary to confirm whether or not the electrical outlet 20 related to the usage request belongs to the business operator to which the user of the vehicle identification information registers. In this case, for example, the management processing section 103 of the server 100 first refers to the area stay database in the storage section 104 to confirm whether or not the vehicle identification information related to the usage request is registered. By this confirmation, it is confirmed that it exists in the parking space 80, next the parking identification information corresponding to the vehicle identification information related to the usage request is acquired from the area stay database, and then the business-operator database in the storage section 104 is referred, and the corresponding business operator identification information is acquired. If this business operator identification information is registered in the user registration database in association with the user of the vehicle identification information related to the usage request, it can be confirmed that the user is the authorized user.

If it is confirmed that the user is the authorized user by the above authentication process, the server 100 outputs a usage permission notification to the vehicle 30, which is the transmission source of the usage request, through the communication network 60 by the supply-target communication section 102 (S7). The vehicle 30 received this usage permission notification starts power supply from the electrical outlet 20 to which the plug 41 is connected to the battery 31 by the battery management system (BMS), thereby charging the battery 31 (S8).

If it is not possible to confirm that the user is the authorized user, the server 100 outputs a usage non-permission notification to the vehicle 30, which is the transmission source of the usage request, through the communication network 60 by the supply-target communication section 102. In this case, the power-usage management service using the electrical outlet 20 may be disabled.

The battery management system (BMS) of the vehicle 30 generates the power usage information (amount of electric power, power-charging start time, power-charging end time, etc.) related to the electric power used to charge the battery 31. After the power-charging is completed, the power usage information is transmitted from the external communication section 32 of the vehicle 30 to the server 100 via the communication network 60 (S9). When this power usage information is received by the supply-target communication section 102 of the server 100, the management processing section 103 executes the power-usage management process for registering the received power usage information at the power-usage management database in the storage section 104 (S10).

In the power-usage management process of the present embodiment 1, for the fee-charge process, at least the power amount information included in the power usage information received from the vehicle 30 is registered at the power-usage management database together with the vehicle identification information of the vehicle 30 and the business operator identification information corresponding to the parking identification information of the parking space in which the vehicle 30 exists. After that, the server 100 uses the power-usage management database to perform the fee-charge process for fee-charging to the user corresponding to the vehicle 30 with the usage fee for this power supply to the vehicle 30.

On the other hand, when the vehicle 30 exits the parking space 80 from the entrance/exit gate 81 of the parking space 80, the gate apparatus 82 communicates with the short-range communication section 33 of the vehicle 30 by the wireless communication section 82a to receive the vehicle identification information of the vehicle 30 from the vehicle 30 (S12). Then, the gate apparatus 82 transmits the received vehicle identification information to the server 100 via the communication network 60 together with the entering/exiting information at the time of exiting and the parking identification information of the parking space 80 by the external communication section 82b (S13). Then, the management processing section 103 of the server 100 deletes the vehicle identification information received from the gate apparatus 82 by the gate communication section 101 from the area stay database in the storage section 104 (S14).

### Embodiment 2

Next, another embodiment of the present invention (hereinafter, this embodiment will be referred to as “embodiment 2”) is described.

In the above-described embodiment 1, the site of the parking space 80 that includes only the electrical outlets 20 managed by the same business operator is set as the disposing area A. The site of the parking space 80 such as a pay-parking is physically partitioned by objects such as walls, and the entrance/exit gate 81 of the parking space 80 is limited, thereby it is possible to manage the vehicle identification information of the vehicles 30 existing (staying) in the parking space 80 (disposing area A) in the area stay database by using the gate apparatus 82 disposed in the entrance/exit gate 81.

However, in the case where the electrical outlet 20 of the charging stand 25 is disposed in a place that is not physically partitioned, the entrance/exit point is not limited, thereby in a configuration such as the gate apparatus 82 that identifies the vehicle 30 passing through the entrance/exit, the vehicle identification information of the vehicles 30 existing in the disposing area cannot be managed by the area stay database.

In addition, in the case where the electrical outlets 20 of the charging stands 25 managed by a plurality of business operators are mixed in the site of a physically partitioned parking space, it is necessary to set a plurality of disposing areas corresponding to each business operator in one parking space. Also in this case, in the configuration in which the gate apparatus 82 identifies the vehicle 30 passing through the entrance/exit of the parking space, the vehicle identification information of the vehicle 30 existing in each disposing area cannot be managed by the area stay database.

Therefore, in the present embodiment 2, the vehicle identification information of the vehicles 30 existing in the disposing area is managed in the area stay database by a configuration different from that of the present embodiment 1 described above. Specifically, a geofence technology is used to set a virtual disposing area. The geofence technology is a technology that establishes a virtual boundary line on the ground and grasps communication terminals entering and exiting the disposing area partitioned by the boundary line. That is, in the present embodiment 2, the vehicle 30 existing in each disposing area is detected based on a position information of the vehicle 30 and a position information of the disposing area.

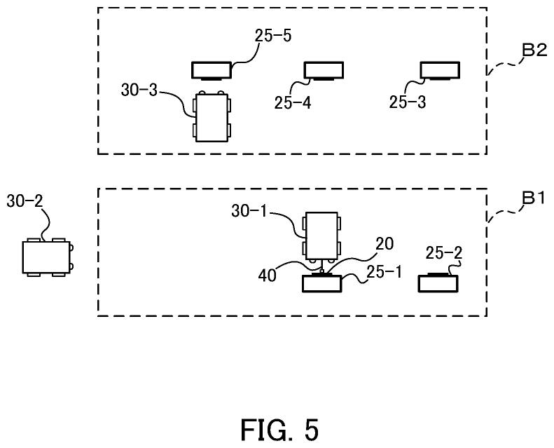

FIG. 5 is an explanatory diagram showing the disposing area in which the electrical outlets 20 is disposed, which configures the power-usage management system according to the present embodiment 2.

In the present embodiment 2, as shown in FIG. 5, two disposing areas B1 and B2 respectively corresponding to two business operators are set as geofence areas so that only electrical outlets 20 managed by the same business operator are included.

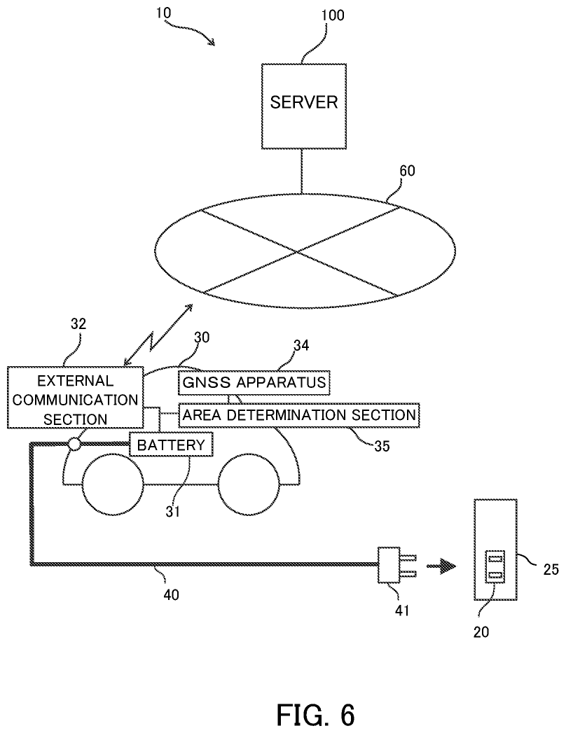

FIG. 6 is an explanatory diagram showing an example of the schematic configuration of the power-usage management system 10 according to the present embodiment 2.

Each vehicle 30 is respectively equipped with a GNSS (Global Navigation Satellite System) apparatus 34, and can acquire positioning results obtained by positioning with the GNSS apparatus 34 as the position information. In addition, each vehicle 30 provided with an area determination section 35 which determines whether or not it has entered or exited the disposing area (each geofence area) B1 or B2 set in advance based on the positioning result (position information) obtained by positioning with the GNSS apparatus 34 provided by itself. In the area determination section 35, the position information of the disposing areas B1 and B2 set in advance is registered beforehand. The position information of the disposing areas B1 and B2, for example, may be received by the external communication section 32 from the server 100 via the communication network 60 and registered at a predetermined timing.

When the area determination section 35 of each vehicle 30 determines that it has entered the disposing area B1 or B2 based on the position information of the disposing area B1 or B2 and the positioning results (position information) obtained by the GNSS apparatus 34, it transmits an area entering notification including area identification information (identification information of the disposing area) for specifying the entered disposing area to the server 100. Also, when it determines that it has exited the disposing area B1 or B2, it transmits an area exiting notification including the area identification information for specifying the exited disposing area to the server 100.

It should be noted that although each vehicle 30 is provided with the area determination section 35 in the present embodiment 2, the server 100 may have a function of the area determination section 35.

Also in the present embodiment 2, the disposing area is set so as to include only the electrical outlets 20 managed by the same business operator. That is, the electrical outlets 20 of the two charging stands 25-1 to 25-2 disposed in the disposing area B1 shown in FIG. 5 is managed by the business operator G1 to provide the power-usage management service, and the electrical outlets 20 of the three charging stands 25-3 to 25-5 disposed in the disposing area B2 shown in FIG. 5 is managed by the business operator G2 to provide the power-usage management service.

By setting the disposing area in this way, a one-to-one correspondence is established between the disposing area and the business operator, thereby even if the electrical outlet 20 that has supplied power to the battery 31 of the vehicle 30 cannot be grasped individually, as long as the disposing areas B1 and B2 where the electrical outlet 20 is disposed can be grasped, it is possible to specify the business operator to manage the electrical outlet 20. Therefore, in the system of the present embodiment 2 as well, in identifying the business operator when electric power is supplied from the electrical outlet 20 to the battery 31 of the vehicle 30, merits such as less equipment load and less processing load can be obtained.

In particular, as in the present embodiment 2, by using the disposing area partitioned by the virtual boundary line such as the geofence, even in the case where the electrical outlet 20 of the charging stand 25 is disposed in a place that is not physically partitioned, the vehicles 30 existing in the disposing area can be grasped, and the vehicle identification information of the vehicles 30 existing in the disposing area can be managed by the area stay database.

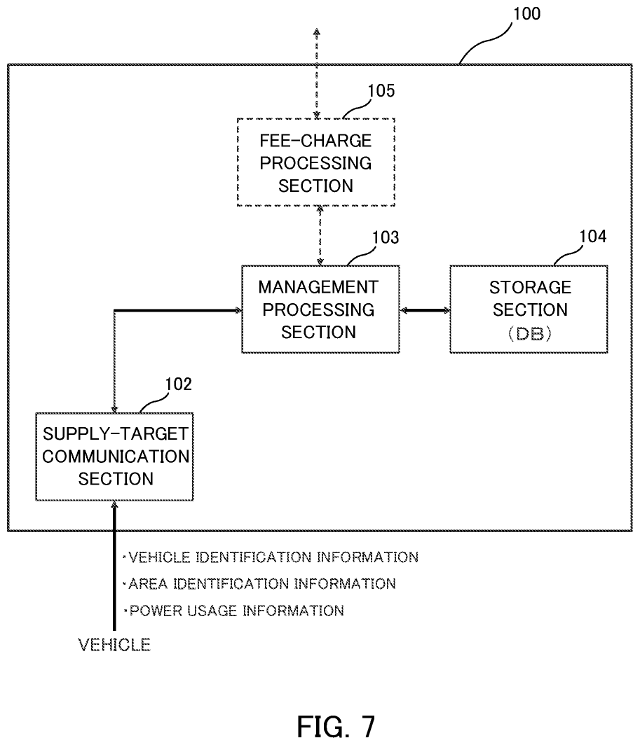

FIG. 7 is a block diagram showing an example of the configuration of main functions of the server 100 according to the embodiment 2.

In FIG. 7, the server 100 of the present embodiment 2 does not need to communicate with the gate apparatus 82, so it does not include the gate communication section 101, but other configurations are the same as those of the embodiment 1 as described above.

In the system of the present embodiment 2, a process of detecting the vehicle 30 existing in the disposing area can be realized by communication between the vehicle 30 and the server 100, thereby there is no need for communication between the gate apparatus 82 and the server 100, so the equipment load, etc. can be reduced.

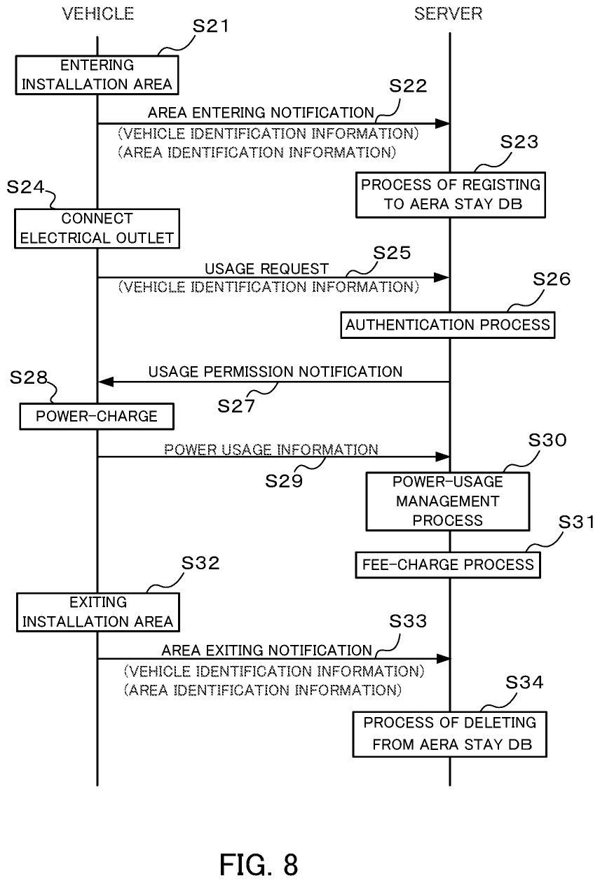

FIG. 8 is a sequence diagram showing an example of the power-usage management process in the embodiment 2.

When the vehicle 30 enters one of the disposing areas B1 and B2, the area determination section 35 of the vehicle 30 determines that it has entered the disposing area based on the position information of the disposing area B1 or B2 and the positioning result (position information) obtained by the GNSS apparatus 34 (S21). Then, from the external communication section 32 of the vehicle 30, an area entering notification including area identification information (identification information of the disposing area) for specifying the entered disposing area and the vehicle identification information of the vehicle 30 is transmitted to the server 100 via the communication network 60 (S22).

The management processing section 103 of the server 100 registers the vehicle identification information and the area identification information received from the vehicle 30 by the supply-target communication section 102 at the area stay database in the storage section 104. Here, since the vehicle has entered the disposing area, the vehicle identification information is registered at the area stay database in association with the area identification information (S23).

Subsequently, when the vehicle 30 receives electric power from the electrical outlet 20 of the charging stand 25 in the disposing areas B1 and B2 to charge the battery 31, the plug 41 of the power cable 40 of the vehicle 30 is connected to the electrical outlet 20 (S24). As a result, a usage request including the vehicle identification information of the vehicle 30 is transmitted from the external communication section 32 of the vehicle 30 to the server 100 via the communication network 60 (S25). When this usage request is received by the supply-target communication section 102 of the server 100, the management processing section 103 executes authentication process similar to that of the embodiment 1 described above (S26).

If it is confirmed that the user is the authorized user by the authentication process, the server 100 outputs a usage permission notification to the vehicle 30, which is the transmission source of the usage request, through the communication network 60 by the supply-target communication section 102 (S27). The vehicle 30 received this usage permission notification starts power supply from the electrical outlet 20 to which the plug 41 is connected to the battery 31 by the battery management system (BMS), thereby charging the battery 31 (S28).

After the power-charging is completed, as in the embodiment 1 described above, the power usage information is transmitted from the external communication section 32 of the vehicle 30 to the server 100 via the communication network 60 (S29). When this power usage information is received by the supply-target communication section 102 of the server 100, as in the embodiment 1 described above, the management processing section 103 executes the power-usage management process for registering the received power usage information at the power-usage management database in the storage section 104 (S30). Further, the fee-charge process is performed in the same manner as in the present embodiment 1 described above (S31).

On the other hand, when the vehicle 30 exits the disposing area B1 or B2, the area determination section 35 of the vehicle 30 determines that it has exited the disposing area based on the position information of the disposing area B1 or B2 and the positioning result (position information) obtained by the GNSS apparatus 34 (S32). Then, from the external communication section 32 of the vehicle 30, an area exiting notification including the area identification information (identification information of the disposing area) for specifying the exited disposing area and the vehicle identification information of the vehicle 30 is transmitted to the server 100 via the communication network 60 (S33). Then, the management processing section 103 of the server 100 deletes the vehicle identification information received from the vehicle 30 by the supply-target communication section 102 from the area stay database in the storage section 104 (S34).

As described above, in the systems of the embodiments 1 and embodiments 2 described above, since the vehicles 30 (or batteries 31), which are power supply targets (energy supply targets), existing in each disposing areas A, B1, and B2 are detected, the vehicle 30 existing in each disposing area A, B1, B2 can be grasped. Then, the server 100 acquires the power usage information (supply information of energy) supplied to the detected vehicle 30, so that the vehicle identification information (identification information of the supply target) of the detected vehicle 30, the power usage information corresponding to the vehicle 30, and the area identification information of the disposing areas A, B1, and B2 where the vehicle 30 is detected are associated with each other by a process executed in the server 100, and managed by various databases in the storage section 104 of the server 100.

According to the embodiments 1 and 2, the disposing areas A, B1 and B2 where the outlets 20 supplying the electric power to the vehicle 30 are disposed are grasped instead of grasping the individual outlets 20 (energy output sections) supplying the electric power to the vehicle 30. According to this, the plurality of outlets 20 disposed in the disposing areas A, B1, and B2 can be collectively managed, so that the equipment load and processing load can be reduced.

By associating the business identification information of the energy business operator with the area identification information of the disposing areas A, B1, and B2 where the electrical outlets 20 managed by the business operator are disposed, for example, the fee-charge process for paying fees from users to the business operator and various process other than the fee-charge process can be managed.

In particular, as in the embodiments 1 and 2, if the disposing areas A, B1, and B2 are partitioned so as to include only electrical outlets 20 (energy output sections) managed by the same business operator, appropriate management becomes possible even in a system in which the electrical outlets 20 individually managed by a plurality of business operators are mixed.

That is, in managing various processes such as fee-charge process, it is necessary to specify the business operator that manages the electrical outlet 20 when electric power is supplied from the electrical outlet 20 to the vehicle 30. At this time, in a method of managing the business operator and the individual outlets 20 in association with each other, it is necessary to individually grasp the electrical outlets 20 supplying electric power to the vehicle 30, thereby easily increasing the equipment load for this grasping and the processing load for this grasping. On the other hand, by partitioning the disposing areas A, B1, B2 so that only the electrical outlets 20 managed by the same business operator are included, the disposing areas and the energy business operators are in one-to-one correspondence. Therefore, even if the electrical outlets 20 that has supplied electric power to the vehicle 30 cannot be grasped individually, as long as the disposing area where the electrical outlet 20 is disposed can be grasped, it is possible to specify the energy business operator to manage the electrical outlet 20.

Further, in the embodiment 1 and 2 described above, the power usage information, which is the supply information of energy, is transmitted from the external communication section 32 mounted on the vehicle 30 (supply target) or the terminal apparatus (communication apparatus) that moves with the vehicle 30 to the server. 100. As a result, there is no need to transmit the power usage information to the server 100 from the side of the power supply equipment such as the electrical outlet 20 and the charging stand 25, so the disposing cost of the power supply equipment is low, and the equipment load is reduced.

Also, in the embodiment 1 and 2 described above, communication between the vehicle 30 and the server 100 is performed by using the external communication section 32 mounted on the vehicle 30, but such an external communication section 32 mounted on the vehicle, a terminal apparatus owned by the user may be used. As the terminal apparatus, for example, a mobile station (also referred to as a “mobile device”, a “user equipment (UE)”, etc.) capable of communicating via a mobile communication network of the fourth generation or the fifth generation or the later generation is used.

When the terminal apparatus possessed by the user is used instead of the external communication section 32 mounted on the vehicle, a user ID or the like used in an application running on the terminal apparatus can be used as identification information of the supply target instead of the vehicle identification information. In addition, when the terminal apparatus is used, as the identification information of disposing area, for example, the positioning result (position information) obtained by positioning with the GNSS apparatus installed in the terminal apparatus can be used, but other information may be used. For example, an imaging apparatus (camera) installed in the terminal apparatus reads the QR code (registered trademark) displayed near the electrical outlet 20 used for charging (charging stand 25 of the electrical outlet 20), and identification information included in this QR code (registered trademark) can be used as the identification information of the disposing area.

Also, when the terminal apparatus is used, the terminal apparatus needs to acquire the power usage information and the like from the side of the vehicle 30. In this case, for example, the transmission request generated by an application running on the terminal apparatus 51 is transmitted to the remote control unit (TCU) of the vehicle via short-range wireless communication, and is acquired from the remote control unit (TCU).

It is noted that process steps and configuration elements such as information processing apparatuses, gate apparatuses, in-vehicle apparatuses of vehicles, and terminal apparatuses described in the present specification can be implemented with various means. For example, these process steps and configuration elements may be implemented with hardware, firmware, software, or a combination thereof.

With respect to hardware implementation, means such as processing sections or the like used for establishing the foregoing steps and configuration elements in entities (for example, computer apparatus, server, gate apparatus, in-vehicle apparatus of vehicle, terminal apparatus (user equipment, mobile station, communication terminal), hard disk drive apparatus, or optical disk drive apparatus) may be implemented in one or more of an application-specific IC (ASIC), a digital signal processor (DSP), a digital signal processing device (DSPD), a programmable logic device (PLD), a field programmable gate array (FPGA), a processor, a controller, a microcontroller, a microprocessor, an electronic device, other electronic unit, computer, or a combination thereof, which are designed so as to perform a function described in the present specification.

With respect to the firmware and/or software implementation, means such as processing sections or the like for using to establish the foregoing configuration elements may be implemented with a program (for example, a code such as a procedure, a function, a module, an instruction, etc.) for performing a function described in the present specification. In general, any computer/processor readable medium of clearly materializing the code of firmware and/or software may be used for implementation of means such as processing sections and so on for establishing the foregoing steps and configuration elements described in the present specification. For example, in a control apparatus, the firmware and/or software code may be stored in a memory and executed by a computer or processor. The memory may be implemented within the computer or processor, or outside the processor. Further, the firmware and/or software code may be stored in, for example, a medium capable being read by a computer or processor, such as a random-access memory (RAM), a read-only memory (ROM), a non-volatility random-access memory (NVRAM), a programmable read-only memory (PROM), an electrically erasable PROM (EEPROM), a FLASH memory, a floppy (registered trademark) disk, a compact disk (CD), a digital versatile disk (DVD), a magnetic or optical data storage section, or the like. The code may be executed by one or more of computers and processors, and a certain aspect of functionalities described in the present specification may be executed by a computer or processor.

The foregoing medium may be a non-temporary recording medium. The foregoing code of the program may be readable and executable by a computer, processor, or other device or apparatus machine, and its format is not limited to a specific format. For example, the foregoing code of the program may be any of source code, object code, and binary code, or may be a mixture of two or more of these codes.

The description of embodiments disclosed in the present specification is provided so that the present disclosures can be produced or used by those skilled in the art. Various modifications of the present disclosures will be readily apparent to those skilled in the art and general principles defined in the present specification can be applied to other variations without departing from the spirit and scope of the present disclosures. Therefore, the present disclosures should not be limited to examples and designs described in the present specification and should be recognized to be in the broadest scope corresponding to principles and novel features disclosed in the present specification.

### REFERENCE SIGNS LIST

10: power-usage management system
20: electrical outlet
25: charging stand
30: vehicle
31: battery
32: external communication section
33: short-range communication section
34: GNSS apparatus
35: area determination section
40: power cable
41: plug
51: terminal apparatus
60: communication network
80: parking place
81: entrance/exit gate
82: gate apparatus
82a: wireless communication section
82b: external communication section
100: server
101: gate communication section
102: supply-target communication section
103: management processing section
104: storage section
105: fee-charge processing section
A, B1, B2: disposing area

1. An information processing apparatus for managing a use of an energy, comprising:
a detection section that performs a detection of an energy supply target existing in each disposing area where an energy output section is disposed;
a supply information acquisition section that acquires supply information of energy to be supplied to the supply target detected by the detection section; and
an association processing section that executes a process of associating with identification information of the supply target detected by the detection section, supply information corresponding to the supply target, the supply information being acquired by the supply information acquisition section, and identification information of a disposing area in which the supply target is detected by the detection section.

2. The information processing apparatus according to claim 1, wherein the disposing area is set by partitioning so as to include only the energy output section managed by a same energy business operator.

3. The information processing apparatus according to claim 2, wherein the information processing apparatus comprises a fee-charge processing section that performs a fee-charge process for a usage fee of the energy supplied to the supply target from the energy output section managed by the energy business operator, with respect to the energy business operator that manages the disposing area identified based on the identification information of the disposing area associated by the association processing section.

4. The information processing apparatus according to any one of claims 1 to 3, wherein the detection section performs the detection by acquiring detection information obtained by detecting a passage of the supply target to the disposing area by a gate apparatus disposed at least one of an entrance and an exit of the disposing area.

5. The information processing apparatus according to any one of claims 1 to 3, wherein the detection section performs the detection based on position information of the supply target and position information of the disposing area.

6. The information processing apparatus according to any one of claims 1 to 5, wherein the supply information acquisition section acquires the supply information transmitted from a communication apparatus that is mounted on the supply target or moves together with the supply target.

7. The information processing apparatus according to any one of claims 1 to 6, wherein the energy used in the supply target is an electric power, the supply information includes an amount of the electric power used in the supply target.

8. The information processing apparatus according to any one of claims 1 to 7, wherein the supply target is a vehicle.

9. A system for managing a use of an energy, comprising:
the information processing apparatus according to any one of claims 1 to 8; and
at least one of a communication apparatus that transmits information used by the detection section to perform the detection, to the information processing apparatus, and a communication apparatus that transmits the supply information acquired by the supply information acquisition section, to the information processing apparatus.

10. A method for managing a use of an energy, comprising:
a detection process of performing a detection of an energy supply target existing in each disposing area where an energy output section is disposed;
an acquisition process of performing an acquisition of supply information of energy to be supplied to the supply target detected in the detection process; and
a processing process of executing a process of associating with identification information of the supply target detected in the detection process, supply information corresponding to the supply target, the supply information being acquired in the acquisition process, and identification information of a disposing area in which the supply target is detected in the detection process.

11. A program executed in a computer provided in an information processing apparatus that manages a use of an energy, whereby the computer is caused to execute,
a detection process of performing a detection of an energy supply target existing in each disposing area where an energy output section is disposed;
an acquisition process of performing an acquisition of supply information of energy to be supplied to the supply target detected in the detection process; and
a processing process of executing a process of associating with identification information of the supply target detected in the detection process, supply information corresponding to the supply target, the supply information being acquired in the acquisition process, and identification information of a disposing area in which the supply target is detected in the detection process.
